(19) United States
(12) Patent Application Publication
(10) Pub. No.: US 2018/0125276 A1
(43) Pub. Date: May 10, 2018

(54) SMART CONTAINER

(71) Applicants: Inventec (Pudong) Technology Corporation, Shanghai (CN); INVENTEC CORPORATION, Taipei City (TW)

(72) Inventor: Yu-Ming TSAI, TAIPEI CITY (TW)

(21) Appl. No.: 15/473,595

(22) Filed: Mar. 29, 2017

(30) Foreign Application Priority Data
Nov. 9, 2016 (CN) 201610982712.7

(51) Int. Cl. A47G 23/12; G01L 9/00; G01K 7/00; G01G 19/40; A47G 19/22; H04Q 9/00

(52) U.S. Cl. CPC A47G 23/12; G01L 9/00; G01K 7/00; H04Q 2209/84; A47G 19/2227; H04Q 9/00; A47G 2019/2238; G01G 19/40

(57) ABSTRACT

A smart container comprises a container body and a base. The container body comprises a sensing circuit, and the sensing circuit is configured to detect a pressure changing value and a temperature changing value both corresponding to a touch operation performed on the opening of the container body. The base disposed underneath the container body, wherein the base comprises a measuring circuit and a processing unit. The measuring circuit configured to measure a weight of contents accommodated in the container body. And the processing unit is configured to determine whether or not the touch operation is performed, configured to calculate a weight changing value according to the weight, and configured to determine a drinking capacity of a user and whether or not the user has drank the contents.

### CROSS-REFERENCE TO RELATED APPLICATION

This application claims the priority benefit of Chinese Application serial no. 201610982712.7 filed Nov. 9, 2016, the full disclosure of which is incorporated herein by reference.

### FIELD OF INVENTION

The invention relates to a smart container. More particularly, the invention relates to a smart container for determining a drinking capacity of a user and whether or not the user has drunk the contents.

### BACKGROUND

Recently, with the prevalence of environmental protection atmosphere and the increase of emphasis on health, the number of people who carry water containers gradually increases.

According to the data of Taiwan Health and Welfare Administration, in general, healthy adults have to drink at least 1500 c.c. per day. However, users could hardly know clearly how much water they have drunk. Users are not only afraid of insufficiency by taking too little water, but also afraid of water intoxication by taking too much water. Therefore, how to effectively measure the drinking capacity and let users know their drinking capacity is one of the problems needed to be addressed in the art.

### SUMMARY

An embodiment of this disclosure is to provide a smart container, comprising a container body and a base. The container body comprises a sensing circuit, wherein the sensing circuit is disposed, inside the container body, close to or located at an opening of the container body, and the sensing circuit is configured to detect a pressure changing value and a temperature changing value both corresponding to a touch operation performed on the opening of the container body. The base is disposed underneath the container body, wherein the base comprises a measuring circuit and a processing unit. The measuring circuit is configured to measure a weight of contents accommodated in the container body. And the processing unit is electrically coupled with the measuring circuit and the sensing circuit, wherein the processing unit is configured to determine, according to the pressure changing value and the temperature changing value, whether or not the touch operation is performed, configured to calculate a weight changing value according to the weight, and configured to determine, according to a result of determining whether or not the touch operation is performed and the weight changing value, a drinking capacity of a user and whether or not the user has drunk the contents.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating a smart container according to some embodiments of the present disclosure.

FIG. 2 is a flow chart illustrating a method For determining whether or not the touch operation is performed on the smart container according to some embodiments of the present disclosure.

FIG. 3 is a flow chart illustrating a method for determining the drinking capacity by the smart container according to some embodiments of the present disclosure.

FIG. 4 is a schematic diagram illustrating a smart container according to some other embodiments of the present disclosure.

### DETAILED DESCRIPTION

The following disclosure provides many different embodiments, or examples, tor implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art, within the context of the invention, and m the specific context where each term is used. Certain terms that are used to describe the invention are discussed below, or elsewhere in the specification, to provide additional guidance to the practitioner regarding the description of the invention.

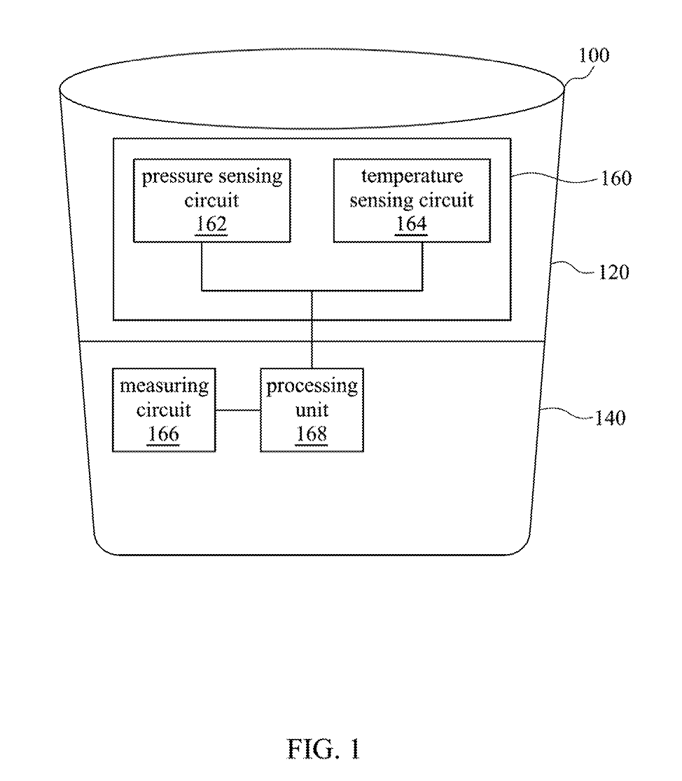

Reference is made to FIG. 1. FIG. 1 is a schematic diagram illustrating a smart container 100 according to some embodiments of the present disclosure. As shown in FIG. 1, the smart container 100 includes a container body 120 and a base 140. The container body 120 includes a sensing circuit 160, in which the sensing circuit 160 is disposed inside the container body 120, close to or located at the opening of the container body 120, and the sensing circuit 160 is configured to detect a pressure changing value and a temperature changing value both corresponding to a touch operation performed on the opening of the container body 120.

In some embodiments, as shown in FIG. 1, the sensing circuit 160 includes a pressure sensing circuit 162 and a temperature sensing circuit 164, in which the pressure sensing circuit 162 is configured to detect the pressure changing value corresponding to the touch operation performed on the opening of the container body 120, and the temperature sensing circuit 164 is configured to detect the temperature changing value corresponding to the touch operation performed on the opening of the container body 120.

In some embodiments, the pressure sensing circuit 162 may be a resistance strain gauge pressure sensor, a semiconductor strain gauge pressure sensor, a piezo-resistive pressure sensor, or other circuits having equivalent pressure sensing function. In some embodiments, the temperature sensing circuit 164 may be a thermocouple temperature sensing circuit, a thermistor temperature sensing circuit, an IC temperature sensing circuit or other circuits having equivalent temperature sensing function.

The base 140 is disposed underneath the container body 120. In some embodiments, the base 140 includes a measuring circuit 166 and a processing circuit 168. The measuring circuit 166 is configured to measure the weight of contents accommodated in the container body 120. The processing unit 168 is electrically coupled with the measuring circuit 166 and the sensing circuit 160. The processing unit 168 is configured to determine, according to the pressure changing value and the temperature changing value, whether or not the touch operation is performed, configured to calculate the weight changing value according to the weight, and configured to determine, according to the weight changing value and the result of determining whether or not the touch operation is performed, the drinking capacity of the user and whether or not the user has drunk the contents.

In some embodiments, the measuring circuit 166 may be an electronic scale sensing circuit, a load sensor circuit or other circuits having equivalent weight measuring function. In some embodiments, the processing unit 168 may be a central processing unit (CPU), a microprocessor, or other similar arithmetic circuits or elements.

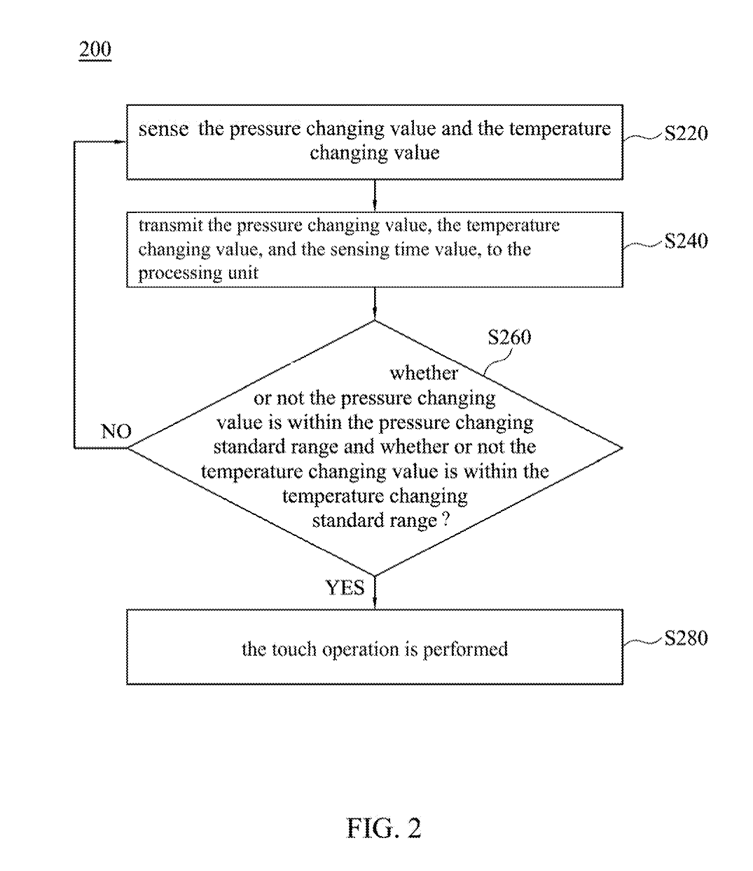

Reference is made to FIG. 2. FIG. 2 is a flow chart illustrating method 200 for determining whether or not the touch operation is performed on the smart container 100, as illustrated in FIG. 1, according to some embodiments of the present disclosure. It should be noted chat the method 200 is not limited to be applied to the smart container 100, as shown in FIG. 1. Method 200 may be applied to any device similar to the smart container 100 and having corresponding elements and/or functions. For clarity of illustration, the following operations related to the method 200 would be illustrated with reference to the smart container 100 shown in FIG. 1.

First, in operation S220, the pressure changing value and the temperature changing value are sensed by the sensing circuit 160, in which the sensing circuit 160 includes the pressure sensing circuit 162 and the temperature sensing circuit 164, which are configured to detect the pressure changing value and the temperature changing value, respectively, corresponding to the touch operation performed on the opening of the container body 120.

Then operation S240 is performed, in which the aforementioned detected pressure changing value, the aforementioned detected temperature changing value and a sensing rime value of the sensing circuit 160 performing the sensing operation, are transmitted to the processing unit 168 by the sensing circuit 160.

After receiving the pressure changing value, the temperature changing value, and the sensing time value of performing the sensing operation, transmitted from the sensing circuit 160, operation S260 is performed. In operation S260, the processing unit 168 determines, according to a pressure changing standard range and a temperature changing standard range stored in the processing unit 168, whether or not the pressure changing value is within the pressure changing standard range and whether or not the temperature changing value is within the temperature changing standard range. If it is determined that the pressure changing value is within the pressure changing standard range and the temperature changing value is within the temperature changing standard range, then operation S280 is performed, and the processing unit 168 determines that the touch operation is performed. If the determination result in operation S260 is no, operation S220 is performed again, and the pressure changing value and the temperature changing value are resumed detected by the sensing circuit 160.

An example related to the pressure changing standard range and the temperature changing standard range stored in the processing unit 168 is as shown in Table 1:

TABLE 1

| | Pressure changing standard | Temperature changing |
|---|---|---|
| | range | standard range |
| Range | 0.1 N-0.3 N | 7° C.-15° C. |

As shown in Table 1, in some embodiments, the pressure changing standard range stored in the processing unit 168 is 0.1N-0.3N and the temperature changing standard range stored in the processing unit 168 is 7° C.-15° C. According to such pressure changing standard range and such temperature changing standard range, for example, if the pressure changing value sensed by the sensing circuit 160 is 0.02N and the temperature changing value sensed by the sensing circuit 160 is 5° C., then it is determined that the touch operation is not performed; if the pressure changing value sensed by the sensing circuit 160 is 0.2N and the temperature changing value sensed by the sensing circuit 160 is 5° C., then it is determined that the touch operation is not performed; if the pressure changing value sensed by the sensing circuit 160 is 0.2N and the temperature changing value sensed by the sensing circuit 160 is 10° C., then it is determined that the touch operation is performed; if the pressure changing value sensed by the sensing circuit 160 is 0.2N and the temperature changing value sensed by the sensing circuit 160 is 20° C., then it is determined that the touch operation is not performed.

The pressure changing standard range and the temperature changing standard range are only given for illustrative purpose. Different settings of the standard range are within the contemplated scope of the present disclosure. Furthermore, the standard range can be adjusted and set according to the temperature of the user's lips, the lip pressure of the user, or the temperature of the contents.

From the above, it is understood that, by determining whether or not the sensing operation is performed, the determination result can be taken as a basis for determining whether or not the user has performed the drinking action. In other words, if the processing unit 168 determines the sensing operation is performed, then it is indicated that the user has performed the drinking action. If the processing unit 168 determines the sensing operation is not performed, then it is indicated that the user has not performed the drinking action.

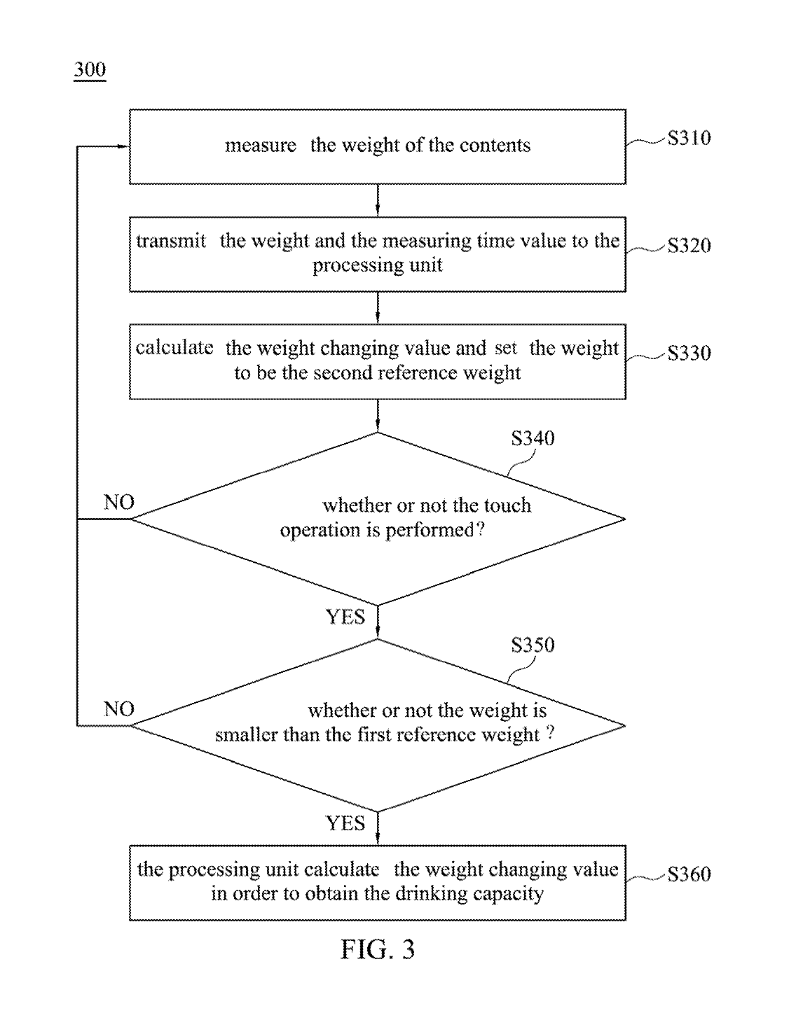

Reference is made to FIG. 3. FIG. 3 is a flow chart illustrating a method 300 for determining the drinking capacity by the smart container 100, as illustrated in FIG. 1, according to some embodiments of the present disclosure. It should be noted that the method 300 is not limited to be applied to the smart container 100, as shown in FIG. 1. Method 300 may be applied to any devices similar to the smart container 100 and having corresponding elements and/or functions. For clarity of illustration, the following procedures related to the method 300 would be illustrated with reference to the smart container 100 shown in FIG. 1.

In operation S310, the measuring circuit 166 measures the weight of the contents in the container body 120. After measuring the weight of the contents, operation S320 is performed, in which the measured weight and the measuring time value of performing the measuring operation are transmitted to the processing unit 168.

After receiving the weight and the measuring time value transmitted by the measuring circuit 166, operation S330 is performed. In operation S330, the processing unit 168 calculates the weight changing value and sets the weight received by the processing unit 168 to be the second reference weight. The aforementioned weight changing value is the difference between the weight received by the processing unit 168 and the first reference weight stored in the processing unit 168, in which the first reference weight is the weight value measured when the operation S310 is previously performed.

For example, if the weight measured when the operation S310 is previously performed is 0.5 kg, then at the moment, the first reference weight stored in the processing unit 168 is 0.5 kg. And if the weight value transmitted by the measuring circuit 166 and received by the processing circuit 168 is 0.2 kg, then the processing circuit 168 would calculates that the weight changing value is 0.3 kg, and the processing circuit 168 would also set the 0.2 kg to be the second reference weight.

For another example, if the measuring circuit 166 measures the weight of 0.5 kg, 0.2 kg and 0.6 kg, respectively, at three time points T1, T2 and T3, and the measuring circuit 166 transmits the weight and the measuring time value to the processing unit 168 at three time points T1, T2 and T3, respectively. Furthermore, no other measuring time point or measuring time value occurs between the three time points T1, T2 and T3. Then at time point T2, the weight changing value calculated by the processing unit 168 is 0.3 kg. And at time point T3, the weight changing value calculated by the processing unit 168 is 0.4 kg.

Reference is made to FIG. 3 again. After the processing unit 168 calculates the weight changing value, operation S340 is performed. In operation S340, the processing unit 168 determines whether or not the touch operation is performed. The procedure, determining whether or not the touch operation has been performed, may be as the procedures illustrated in the method 200 of FIG. 2, and it would not be described in detail here. And then, if the determination result of operation S340 is yes, then operation S350 is performed, and the processing unit 168 determines whether or not the weight is smaller than the first reference weight. If the determination result of operation S340 is no, operation S310 is performed again, and the weight of the contents are resumed measured by the measuring circuit 166.

Reference is made to FIG. 3 again. If the determination result of operation S340, determining whether or not the touch operation is performed, is yes, then operation S350 is performed. In operation S350, the processing unit 168 determines whether or not the weight is smaller than the first reference weight. If the determination result of operation S350 is yes, then operation S360 is performed. In operation S360, the processing unit 168 calculates the weight changing value in order to obtain the drinking capacity. When the contents are water, the processing unit 168 may directly determine the weight changing value is the drinking capacity. On the other hand, if the determination result of operation S350 is no, operation S310 is performed again, and the weighs of the contents are resumed measured by the measuring circuit 166.

Based on the above, if the weight is smaller than the first reference weight, it indicates that the contents in the container body 120 have decreased. If the weight is bigger than the first reference weight, it indicates that the contents in the container body 120 have increased. Therefore, if it is determined that the touch operation is performed and the weight is smaller than the first reference weight, it indicates that the user has drunk the contents in the container body 120. In other words, if both of the determination result of operation S340 and operation S350 are yes, then it is determined that the user has drunk the contents in the container body 120.

For example, if the measuring circuit 166 measures the weight of 0.5 kg, 0.2 kg and 0.6 kg, respectively, at three time points T1, T2 and T3, and the measuring circuit 166 transmits the weight and the measuring time value to the processing unit 168 at three time points T1, T2 and T3, respectively. Furthermore, no other measuring time point or measuring time value occurs between the three time points T1, T2, and T3. Then at time point T2, the processing unit 168 would determine, in operation S350, the weight (0.2 kg) is smaller than the first reference weight (0.5 kg). Therefore, the processing unit 168 would perform operation S360 and determines the drinking capacity of the user is equal to the weight changing value (0.3 kg).

In addition, at time point T3, the processing unit 168 would determine, in operation S350, the weight (0.6 kg) is bigger than the first reference weight (0.2 kg). Under such circumstances, it indicates that the contents of the container body 120 have increased. Therefore, the processing unit 168 would not determine the drinking capacity of the user is equal to the weight changing value.

According to some embodiments of the present disclosure, the processing unit 168 further calculates the liquid capacity according to the weight changing value and the liquid density value predetermined by the processing unit 168. Under the circumstances without special settings, the processing unit 168 would determine the contents in the container body 120 is water and set the liquid density value to be 1. Therefore, while executing operation S360, the drinking capacity of the user is directly determined to be equal to the weight changing value.

In some other embodiments, if the contents in the container body 120 are not water but other liquids, the liquid density value stored in the processing unit 168 may be set to be other value, and the liquid capacity is calculated according to the weight changing value and the liquid density value. For example, if the contents in the container body 120 are milk, then the liquid density value stored in the processing unit 168 may be set to be 1.03, and if the weight measured by measuring circuit 166 is 0.103 kg, then, it can be calculated that the drinking capacity is 0.1 liter.

In some embodiments, when the measuring circuit 166 performs operation S310 and operation S311, it also measures whether or not the pressure of the contents, in the container body 120, is averaged relative to the measuring circuit 166. And when the pressure is averaged, the weight of the contents and the measuring time value of the measuring circuit 166 performing the measuring operation are transmitted to the processing unit 168. In some embodiments, the measuring circuit 166 may perform operation S310 and operation S311 only when the smart container 100 is placed in a static state.

For example, in some embodiments, the measuring circuit 166 includes measuring unit blocks (not shown). When measuring whether or not the pressure of the contents, in the measuring container body 120, relative to the measuring circuit 160 is averaged, the measuring unit blocks of the measuring circuit 166 may measure and obtain measuring pressures, respectively. When the measuring pressures are equal, it is determined that the pressure of the contents relative to the measuring circuit 166 is averaged.

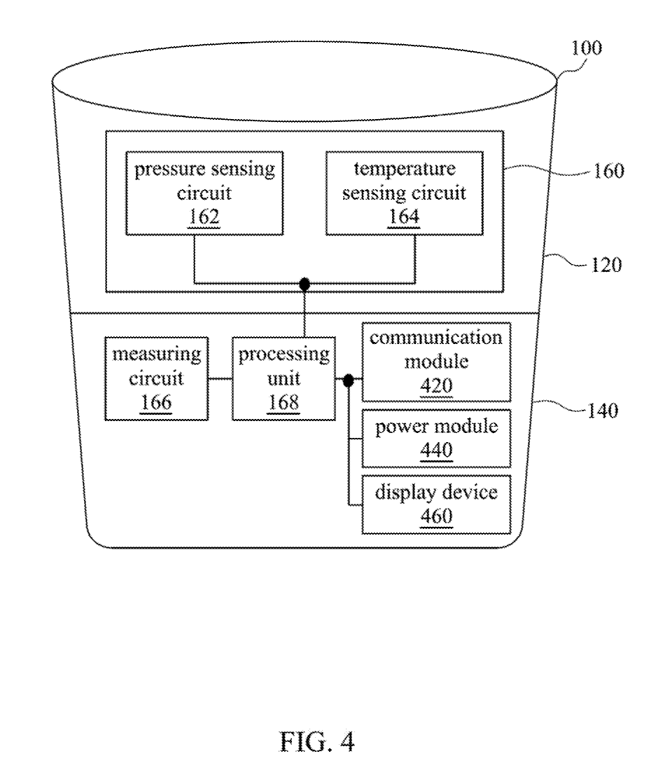

Reference is made to FIG. 4. FIG. 4 is a schematic diagram illustrating a smart container 100 according to some other embodiments of the present disclosure. Compared to the smart container shown in FIG. 1, in some embodiments, the smart container 100 shown in FIG. 4 further includes a communication module 420. The communication module 420 is configured to be connected to a mobile device and transmit the weight and the drinking capacity to the mobile device. In some embodiments, the communication module 420 may also transmit the measuring time value and the sensing time value to the mobile device. In some embodiments, the mobile device includes applications. The functions of the applications comprise calculating, according to the drinking capacity, the drinking amount of the user in a certain period of time; and setting, according to the height, of the user or the amount of the user's daily activity, the drinking amount that the user needs to consume.

For example, in some embodiments, the communication module 420 transmits three pieces of information to the mobile device, in which the first information includes the measuring time value of 8:00:00, sensing time value of 7:59:00, and the drinking capacity of 0.2 liter. The second information includes the measuring time value of 8:30:00, sensing time value of 8:28:30, and the drinking capacity of 0.6 liter. The third information includes the measuring time value of 9:20:00, sensing time value of 9:17:00, and the drinking capacity of 0.9 liter. Based on the above, the applications may calculate the drinking amount of the user between the periods of 8:00:00 to 9:00:00 is 0.8 liter.

In some embodiments, the mobile device may be a smart phone, a personal computer, a tablet, a personal digital assistant, or alike. In some embodiments, the communication module 420 may be a Bluetooth transmission chip, a Wi-Fi chip, a fourth generation of mobile phone mobile communication technology standards (4G) chip, a third generation of mobile phone mobile communication technology standards (3G) chip, a second generation of mobile phone mobile communication technology standards (2G) chip, or other processing circuits with equality.

Reference is made to FIG. 4. In some embodiments, the smart container 100 further includes a power module 440. The power module 440 may be at least one of an independent power module, a mobile power module and a wireless charging module, and the power module is configured to supply power required by the smart container 100 and/or to supply power to a device connected to the smart container 100.

Reference is made to FIG. 4. In some embodiments, the smart container 100 further includes a display device 460. The display device 460 is configured to display at least one of the weight, the drinking capacity and time. The display device 460 may be a liquid crystal display, a light emitting diode display, or alike.

In this document, the term “coupled” may also be termed as “electrically coupled”, and the term “connected” may be termed as “electrically connected”. “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A smart container, comprising:
a container body comprising a sensing circuit, wherein the sensing circuit is disposed, inside the container body, close to or located at an opening of the container body, and the sensing circuit is configured to detect a pressure changing value and a temperature changing value both corresponding to a touch operation performed on the opening of the container body;
a base disposed underneath the container body, wherein the base comprises:
a measuring circuit configured to measure a weight of contents accommodated in the container body; and
a processing unit electrically coupled with the measuring circuit and the sensing circuit, wherein the processing unit is configured to determine, according to the pressure changing value and the temperature changing value, whether or not the touch operation is performed, configured to calculate a weight changing value according to the weight, and configured to determine, according to a result of determining whether or not the touch operation is performed and the weight changing value, a drinking capacity of a user and whether or not the user has drunk the contents.

2. The smart container of claim 1, wherein the processing unit is further configured to:
determine, according to a pressure changing standard range and a temperature changing standard range stored in the processing unit, whether or not the pressure changing value is within the pressure changing standard range and whether or not the temperature changing value is within the temperature changing standard range; and
determine that the touch operation is performed if the pressure changing value is within the pressure changing standard range and the temperature changing value is within the temperature changing standard range.

3. The smart container of claim 1, wherein the processing unit is further configured to calculate the weight changing value of the weight with respect to a first reference weight, and configured to set the weight to be a second reference weight.

4. The smart container of claim 3, wherein if it is determined that the touch operation is performed and the weight is smaller than the first reference weight, the processing unit is configured to determine that the drinking capacity is equal to the weight changing value.

5. The smart container of claim 4, wherein the processing unit is further configured to calculate the drinking capacity according to the weight changing value and a liquid density value stored in the processing unit.

6. The smart container of claim 1, wherein the measuring circuit is further configured to measure whether or not a pressure of the contents relative to the measuring circuit is averaged, and when the pressure is averaged, configured to transmit the weight of the contents and a measuring time value of the measuring circuit performing a measuring operation, to the processing unit.

7. The smart container of claim 1, wherein the sensing circuit comprises a pressure sensing circuit and a temperature sensing circuit configured to obtain the pressure changing value and the temperature changing value, respectively, and configured to transmit the pressure changing value, the temperature changing value, and a sensing time value of the sensing circuit performing a sensing operation, to the processing unit.

8. The smart container of claim 1, further comprising:
a communication module configured to be connected to a mobile device and transmit the weight and the drinking capacity to the mobile device.

9. The smart container of claim 1, further comprising:
a power module, wherein the power module is at least one of an independent power module, a mobile power module and a wireless charging module, and the power module is configured to supply power required by the smart container and/or to supply power to a device connected to the smart container.

10. The smart container of claim 1, further comprising:
a display device configured to display at least one of the weight, the drinking capacity and time.
